(19) United States
(12) Patent Application Publication
(10) Pub. No.: US 2007/0271074 A1
(43) Pub. Date: Nov. 22, 2007

(54) MULTI-SECTION TRANSMISSION LINE

(75) Inventor: David Seymour Sharman, Newburgh, IN (US)

Correspondence Address: C RICHARD MARTIN;MARTIN & MARTIN, PO BOX 29, BOONVILLE, IN, 47601, US

(73) Assignee: Electronics Research, Inc., Chandler, IN (US)

(21) Appl. No.: 11/308,856

(22) Filed: May 16, 2006

(51) Int. Cl. G06F 17/10

(52) U.S. Cl. 703/2

(57) ABSTRACT

A segmented transmission line used for the transfer of radio frequency energy in which the lengths of the individual segments are individually set to provide an optimally low reflection coefficient over specified frequency ranges.

### FIELD OF THE INVENTION

The present invention relates to rigid coaxial radio frequency transmission lines particularly those intended for carrying high power television and FM radio signals. Certain aspects of the invention are additionally applicable to non-coaxial waveguides and certain semi-flexible waveguides.

### BACKGROUND OF THE INVENTION

For various high power applications, e.g. television transmission or linear accelerators, it is conventional to couple the power source and the power load, e.g. an antenna, using rigid transmission line. Further, in many applications, the power source is located a substantial distance from the load so that the transmission line necessarily comprises multiple sections which most often include a number of elbows to facilitate routing. Traditionally, such multiple sections are essentially all of the same length to simplify design and to afford manufacturing economies.

To prevent the in-phase addition of periodically occurring reflections, section lengths are selected not to be a multiple of a half wavelength at the designated operating frequency, e.g. at the frequency of the TV channel. Modern trends involve the use of a single transmission line for the power transmission from multiple TV or other power sources operating at different frequencies. In many instances no suitable single length can be found that is not a multiple of a half wavelength at or impractically near one or more of the operating frequencies.

A number of schemes involving the systematic tapering of individual lengths or of groups of lengths have been proposed as a means of overcoming this problem. Although these schemes eliminate the full addition of periodically occurring reflections, they tend to give a substantially inferior voltage standing wave ratio (VSWR) compared with that available from a constant section length transmission line dedicated to a single signal. These schemes also cannot readily take account of the variation with frequency of the reflection magnitude of transmission line sections, nor can they readily take account of the characteristics of other essential transmission line components such as elbows, transformers, adapters, etc. Further, in providing a low VSWR over a single wide band of frequencies, they compromise the achievement of the lowest VSWR in specific operating channels.

Among the several objectives of the present invention are: the provision of multi-section transmission line systems having a lower VSWR over bands of frequencies than that achieved by methods heretofore disclosed; the provision of such a transmission line which can be constructed in the form of a rigid or semi-rigid transmission line; the provision of such a transmission line having outer conductors connected together at flange joints; the provision of such a transmission line which is highly reliable and is of relatively simple and inexpensive construction. Other objectives and features will be in part apparent and in point pointed out hereinafter.

### SUMMARY OF THE INVENTION

Briefly, the present invention involves a multi-section run of radio-frequency (RF) transmission line having low VSWR characteristics over a band or bands of frequencies F1a to F1b, F2a to F2b, etc. The transmission comprises a sequence of N sections connected by joints which cause impedance discontinuities. In accordance with this invention, the lengths l of the N sections are distributed essentially according to the relationship

$${l}_{n} = L + {\sum }_{k = 0}^{k - m} {{A}_{k} ( \frac{n}{N} )}^{k}$$

for n=1 to N, where L is the nominal section length, k is a summation integer whose value ranges from zero to a value m which latter value is greater than 1 but less than or equal to N, and Aₖ are constants three of which must be non-zero and which are set such that the VSWR of the transmission line best matches a target minimum for each of the frequency bands F1a to F1b, F2a to F2b, etc. The resulting lengths lₙ are further adjusted by rounding their values to the nearest multiple of a selected fraction of a wavelength at the highest operating frequency.

### BRIEF DESCRIPTION OF THE DRAWINGS

FIG. 1 is a diagrammatic representation of a transmission line embodying certain aspects of the present invention.

FIG. 2 is an exploded sectional side view along the line 2-2 of FIG. 1, of the joint between two sections of the line of FIG. 1 showing the flange joint which connects the outer conductors and a connector which joins the inner conductors of each coaxial section.

FIG. 3 is a side sectional view along the line 3-3 of FIG. 1, of the joint between a section of the line and an elbow FIG. 1 and showing the flange joint which connects the outer conductors and a connector which joins the inner conductors of each coaxial section.

FIG. 4 is a graphical representation of the VSWR versus frequency of a transmission line using equal lengths sections in accordance with prior art.

FIG. 5 is a graphical representation of the VSWR versus frequency of a transmission line using tapered section lengths in accordance with prior art.

FIG. 6 is graphical representation of the VSWR versus frequency of a transmission line example embodying this invention.

### DESCRIPTION OF THE PREFERRED EMBODIMENT

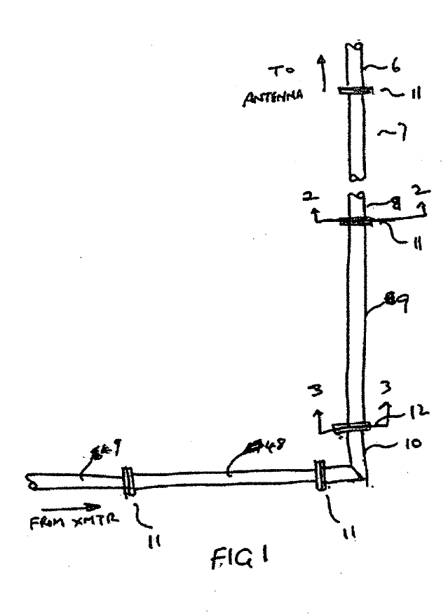

Referring to FIG. 1, the run of transmission line illustrated there comprises a plurality of sections 6, 7, 8,9, 48 and 49 and an interposed transmission line elbow 10, joined by flanged connections 11 and 12. As is understood, such a multi-section run of coaxial transmission line may be used to connect a television transmitter to an antenna located an appreciable distance away. Such lengths necessarily comprise sections since the length of a transmission line segment that can be shipped is limited, as are the lengths of appropriate tubing available commercially. In the particular embodiment being described by way of example, the outer conductors of the coaxial transmission are six and one eighth inch diameter and the individual lengths are nominally 232 inches long, or thereabout.

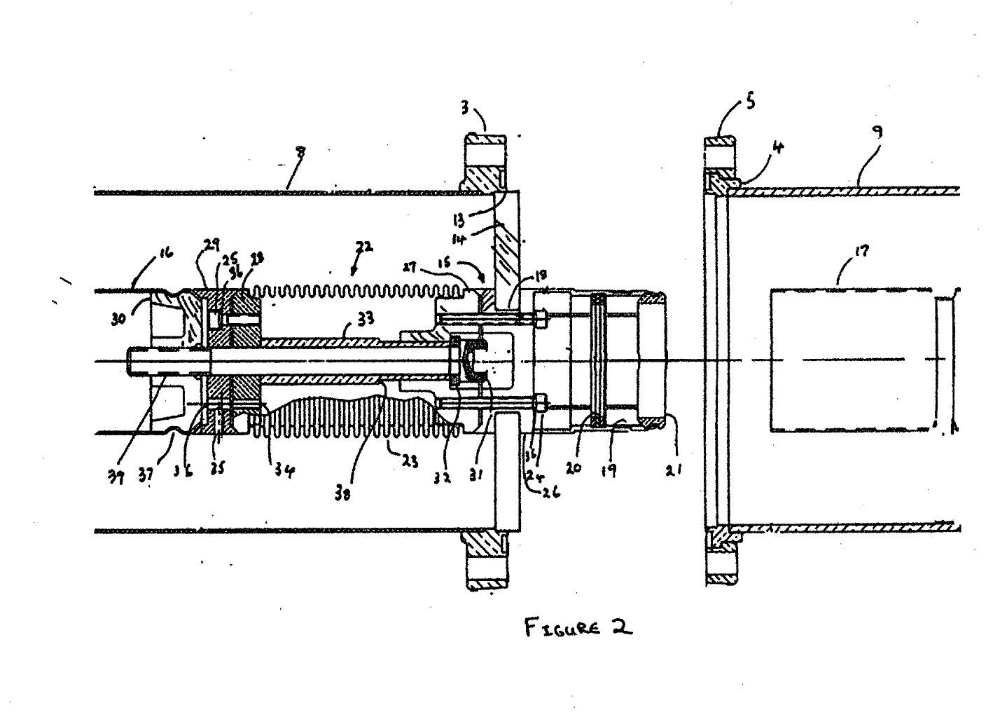

Referring now to FIG. 2 depicting flanged connection 11, the outer conductors of adjacent coaxial line sections are designated by reference characters 1 and 2. A one piece coupling flange 3 is welded to the right hand end of outer conductor 1 while conductor 2 is provided with a two part assembly having an inner ring 4 and an outer rotatable clamping ring 5 which can be bolted to the flange 3 to draw the two sections together into an intimate electrical contact.

The flange 3 and the ring 5 are cut away, as illustrated, to provide a recess 13, which can capture and retain an annular support insulator 14 when the outer sections are bolted together. The support insulator 14 serves to locate a coupler assembly 15, which joins together adjacent inner conductor sections 16 and 17. The support insulator 14 is received within a groove 18, in the coupler assembly 15. Support insulator 14 may, for example, be constructed of poly tetrafluoroethylene (PTFE) and is preferably split so as to allow it to be assembled over the coupler assembly.

The right-hand side of the coupler assembly 15 includes a connecting portion 26, which is essentially conventional and is adapted to fixedly attach to the adjacent end of the respective inner conductor 2. The end of the connecting portion 26 is axially cut at several circumferential locations so as to form radially compliant fingers 19. These fingers are then resiliently forced outwardly into firm contact with the inner conductor 2 by snap ring springs 20. An annular plug 21 prevents splitting the fingers apart if there is an initial misalignment during assembly.

The left-hand side of the coupler assembly 15 also includes a connecting portion 22, which is adapted to attach to the respective inner conductor 1. This connecting portion 22 comprises a spacer-guide 33, a guided right-hand insert 27, a left-hand insert 28, a cap screw 31 and washer 32, a clamp 29, and also provides a cylindrical bellows 23 which functions as explained hereinafter. Guided right-hand insert 27 is held inside the right-hand extremity of the bellows 23 by the inwards deformation in a uniform manner of the bellows 23 to match the profile of the insert 27. Similarly, the left-hand insert 28 is held inside the left-hand end of the bellows 23 by the deformation of the left hand extremity of the bellows 23. The bellows 23 is constrained to compress or extend in an axial direction only by the sliding of the guided right-hand insert 27 on the guide 33. Constraints are placed on the extent of extension or contraction of bellows 23 by the shoulder 38 on the guide and by the cap screw 31 and washer 32. The connection of the bellows 23 to the right-hand portion of the coupler assembly 26 is secured by screws 24 and washers 36. The connection of the bellows to the clamp 29 is secured by screws 25 and washers 36.

The right-hand end of inner conductor 16 is inwardly deformed in a uniform manner to match the profile of internally-threaded inner conductor insert 30. Dimples 37 are formed in the inner conductor 16 to match dimples in inner conductor insert 30 thereby facilitating the retention of inner conductor insert 30 in its correct position during the deformation process. Coupler assembly 15 is secured to inner conductor 16 by the insertion of cap screw 31 into a threaded portion 39 of internally-threaded insert 30.

As will be understood the left-hand of the inner conductor section 16 will be fixedly attached with respect to its corresponding outer conductor section by the last connector 15 in the series of coaxial sections in the same manner as the left hand end of the inner conductor section 17. Thus as differential expansion occurs between the inner and outer conductors, the right hand end of inner conductor 16 will move axially with respect to the coupler member 26. The bellows 23 freely permits this axial movement while maintaining radial alignment and continuity of the electrical path. The holes 34, 35 and 36 function to allow the air pressure inside the inner conductor 16 and the bellows 23 to match that outside these components thus avoiding possible damage through an excessive pressure differential. Such connection configurations have been used heretofore in various connector environments and are conventionally referred to as bullet-bellows assemblies.

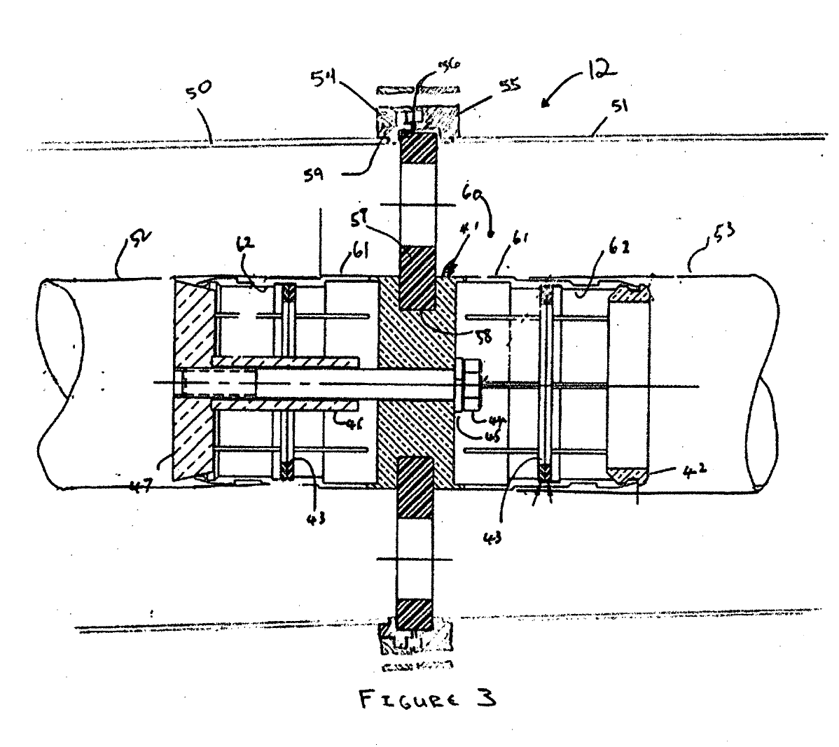

Referring now to FIG. 3 depicting flanged connection 12, the outer conductors of adjacent coaxial line sections are designated by reference characters 50 and 51. A one piece coupling flange 55 is welded to the right hand end of outer conductor 51 while conductor 50 is provided with a two part assembly having an inner ring 59 and an outer rotatable clamping ring 54 which can be bolted to the flange 55 to draw the two sections together into an intimate electrical contact.

The flange 55 and the ring 59 are cut away, as illustrated, to provide a recess 56, which can capture and retain an annular support insulator 57 when the outer sections are bolted together. The support insulator 57 serves to locate a coupler assembly 60, which joins together adjacent inner conductor sections 52 and 53. The support insulator 57 is received within a groove 58, in the coupler assembly 60. Support insulator 57 may, for example, be constructed of poly tetrafluoroethylene (PTFE) and is preferably split so as to allow it to be assembled over the coupler assembly.

Coupler assembly 60 includes a body 41 which is adapted to fixedly attach to the adjacent end of the respective inner conductors 52 and 53. Both end portions 61 of the coupler body 41 are axially cut at several circumferential locations so as to form radially compliant fingers 62. These fingers are then resiliently forced outwardly into firm contact with the inner conductors 52, 53 by snap ring springs 43. An annular plug 42 prevents splitting apart the fingers 62 of the right-hand end of the coupler body 41 if there is an initial misalignment during assembly.

The left-hand side of the coupler assembly 60 also includes a means of positive retention, of the left-hand inner conductor 52 by coupler assembly 60, comprising a spacer sleeve 46, a cap screw 44, a lock-washer 45, and an internally-threaded conical plug 47 which conical plug is in intimate peripheral contact with the tips of the fingers 62 of the coupler body 41. It will be recognized that tightening the aforementioned cap screw 44 will cause the plug 47 to be drawn into the coupler body 41 thereby causing the fingers 62 to deflect radially thus substantially increasing the contact force between said fingers and the internal surface of inner conductor 52 and thereby causing the desired effect of positive retention. Such connection configurations have been used heretofore in various connector environments and are conventionally referred to as bullet assemblies.

While the flanged connectors 11 and 12 are preferably designed so as to introduce a minimal impedance discontinuity, such flanged joints do necessarily introduce some reflection. In accordance with the present invention the actual length of the individual sections 6-9 are varied systematically around a nominal length so as to minimize the accumulation of reflections from the flanged connector discontinuities. In particular, it has been found that a particular regime for length selection provides a highly advantageous low VSWR characteristic over bands of frequencies.

In the preferred embodiment illustrated, this systematic variation in length is implemented as follows. The individual section lengths are assumed to be in the order of seventeen to twenty feet, which nominal length is designated as L in the formula described hereinafter, and which, in this example, is 232.32 inches. The transmission line is intended to operate over bands of frequencies F1a to F1b, F2a to F2b, etc. In this example these frequencies correspond to the lower and upper frequency limits of UHF TV channels 22, 25, 27, 34, 35, 39, 40, 42. In accordance with this invention, the lengths l of the N sections are distributed essentially according to the relationship

$${l}_{n} = L + {\sum }_{k = 0}^{k - m} {{A}_{k} ( \frac{n}{N} )}^{k}$$

for n=1 to N, where L is the nominal section length, k is a summation integer whose value ranges from zero to a value m which latter value is greater than 1 but less than or equal to N, and Aₖ are constants three of which must be non-zero and which are set such that the VSWR of the transmission line best matches a target minimum for each of the frequency bands F1a to F1b, F2a to F2b, etc. The resulting lengths lₙ are further adjusted by rounding their values to the nearest multiple of a selected fraction of a wavelength at the highest operating frequency. This fraction is selected such that its effect on VSWR is negligible, that is, below the level of uncertainty, in the prediction of VSWR, due to the slight random variations in individual flange joint contributions caused by normal manufacturing processes. This rounding has the desirable effect of reducing the number of differing lengths, thus reducing manufacturing and assembly costs. In this example, the value used is 0.05 inches, that is 0.0027 wavelength at 644 MHz, the upper limit of TV channel 42, and this rounding reduces the number of different lengths from 83 to 18.

As heretofore indicated the value of L has been set to 232.32″. Practitioners of the art will recognize that this value is near-enough the optimum for transmission line of equal length sections carrying the aforementioned channels 22-42. In this example, the total length has been assumed to be 1600 feet. Hence the value of N is 83 to the next whole number.

Practitioners of the art will recognize that the selection of the constants Aₖ may be made by any one of the manifold mathematical methods used to find the minimum of a function in an m−1 dimensional space. In this example, the least p^{th} approximation is used to find extremely near minimax optimum. That is, the function being minimized is

$$F = \sqrt[\frac{1}{F}]{{\sum }_{f} {\vert {ρ}_{f} \vert}^{F}}$$

where ρ_{f} is the transmission line reflection coefficient at frequency f, and the exponent p gives emphasis in the summation to the reflection peaks. F may be further modified by placing emphasis on analog rather than digital channels, for example, but has not been done in this example. In the example, it was found that a value of 16 for p produced satisfactory results. In this example, it was also found that a value of 14 for the aforementioned maximum exponent of n, that is m, produced satisfactory results.

Practitioners of the art will also recognize, that for the small values of the individual reflection coefficients, such as occur in well designed transmission lines, it is sufficiently accurate to obtain ρ_{f} by simple summation. That is:

$${ρ}_{f} = {\sum }_{m} {ρ}_{m} ( f ) α ( f , {D}_{m} ) {e}^{\frac{- 4 j π {D}_{m} f}{11800}} + {ρ}_{l} ( f ) α ( f , {D}_{l} ) {e}^{\frac{- 4 j π {D}_{m} f}{11800}}$$

where: ρₘ(f) is the frequency dependent reflection from individual flanged connections 11 and 12; α(f,Pₘ) is the frequency dependent attenuation of the m^{th} reflection; and Dₘ is the reflection distance; and those symbols with the subscript e relate correspondingly to the elbow 10. For simplicity of presentation of the example, it has been assumed that all reflections ρₘ(f) are equal, constant with frequency, and have a value of 0.0035, and that the reflection from the elbow ρₑ are essentially zero.

It will be recognized, by practitioners of the art, that there will be practical circumstances in which certain of the distances to reflections will be fixed by physical constraints, in which circumstances the heretofore described methodology is applied only to those flanges whose locations permit adjustment. Such reflections may include but not be limited to, for example, those of transmission line elbows, reducers, transformers, and gas barriers.

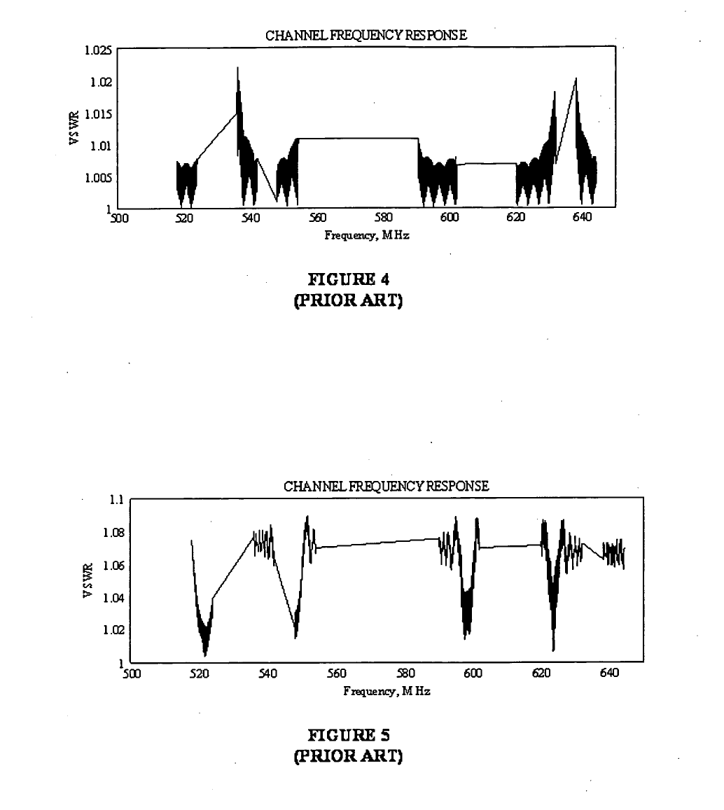

Referring to FIG. 4, the VSWR versus frequency for the eight channels aforementioned is depicted for the transmission line of the said aforementioned example but wherein the sections are of equal length set to 232.32 inches, in accordance with the prior art. Practitioners of the art will recognize that this value for the section length will give a near minimum peak value of VSWR for this set of eight channels.

Referring to FIG. 5, the VSWR versus frequency for the eight channels of the aforementioned example is depicted for the transmission line of the said aforementioned example but wherein the sections are of tapering length, in accordance with prior art, and set to a mean length of 232.32 inches. Practitioners of the art will recognize that this method will give inferior performance over the particular channels of this example, even if the mean length and the degree of taper are adjusted to other values practical values.

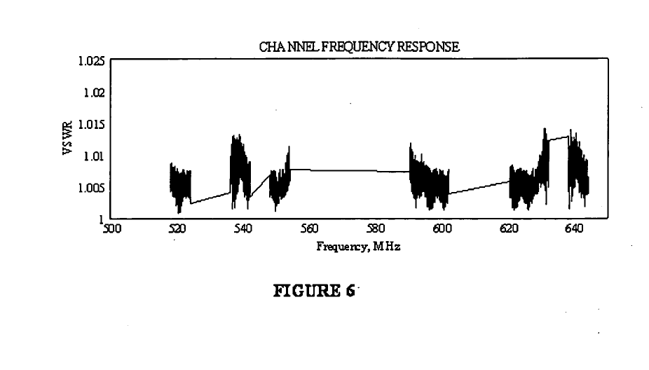

Referring to FIG. 6, the VSWR versus frequency for the eight channels of the aforementioned example is depicted for the transmission line of the said aforementioned example wherein the sections have been adjusted in accordance with the methods and formulas of this invention. It may be seen that these methods and formulas produces a significant improvement over the methods and formulas of prior art.

In view of the forgoing it may be seen that the several advantages of the present invention have been achieved and that other advantageous results have been attained.

Practitioners of the art will recognize that, as well as being applied to rigid coaxial transmission lines, this invention is equally applicable to other types of transmission line constructed in sections such as, but not limited to, semi-flexible coaxial transmission lines with corrugated conductors, and hollow circular, elliptical, rectangular and rectangular and other waveguides with and without ridges.

As various changes could be made in the above constructions without departing from the scope of the invention, and that various other formulas could be applied but which could be reduced mathematically and practically to the formulas of this invention, it should be understood that all matters contained in the above description or shown in the accompanying drawings shall be interpreted as illustrative and not in a limiting sense.

What is claimed is:

1. A multi-section transmission line having low VSWR characteristics over bands of frequencies comprising a sequence of N sections of transmission line having respective lengths l connected in series by a corresponding sequence of joints which cause small impedance perturbations, wherein the lengths l of the N sections are distributed essentially according to the relationship
$${l}_{n} = L + {\sum }_{k = 0}^{k - m} {{A}_{k} ( \frac{n}{N} )}^{k}$$
for n=1 to N, where L is a nominal section length, k is a summation integer whose value ranges from zero to a value m which latter value is greater than 1 but less than or equal to N, and Aₖ are constants three of which must be non-zero, and n is a designator for the respective section.

2. The multi-section transmission line according to claim 1, wherein each joint of said sequence of joints comprises a flanged joint.

3. The multi-section transmission line according to claim 2, wherein each of the said sections of transmission line comprises a tubular conductor and said joint flanges.

4. The multi-section transmission line according to claim 3, wherein the length of each of said sections of transmission line is adjusted to be equal to the nearest integer multiple of a sub-multiple of the major cross-sectional dimension of the transmission line where said a sub-multiple does not exceed one part in twenty.

5. The multi-section transmission line according to claim 2 wherein each of the said sections of transmission line comprises an inner tubular conductor and an outer tubular conductor which are supported in concentric relationship to each at each of said flange joints by a flange insulator.

6. The multi-section transmission line according to claim 5 wherein said flange insulator supports an expansion joint which permits relative longitudinal movement of adjacent ends of successive inner conductors thereby to accommodate differential expansion of said inner and outer conductors.

7. The multi-section transmission line according to claim 5 wherein some of said flange insulators support an expansion joint which permits relative longitudinal movement of adjacent ends of successive inner conductors thereby to accommodate differential expansion of said inner and outer conductors.

8. The multi-section transmission line according to claim 5 wherein the lowermost frequency of the lowermost band of frequencies is greater than or equal to 54 MHz and wherein the uppermost frequency of the uppermost band of frequencies is less than or equal to 806 MHz.

9. The multi-section transmission line according to claim 5 wherein the length of each of the said sections of transmission line is adjusted to be equal to the nearest integer multiple of a sub-multiple of the wavelength of the uppermost frequency of the uppermost frequency band where said a sub-multiple does not exceed one part in thirty.

10. A multi-section transmission line having low VSWR characteristics over bands of frequencies comprising a sequence of N sections of transmission line joined at respective junctioning each one of said N sections having respective lengths l and comprising a tubular conductor, each junction causing small impedance discontinuities, the lengths l of the N sections are distributed essentially according to the relationship
$${l}_{n} = L + {\sum }_{k = 0}^{k - m} {{A}_{k} ( \frac{n}{N} )}^{k}$$
for n=1 to N, where L is a nominal section length, k is a summation integer whose value ranges from zero to a value m which latter value is greater than 1 but less than or equal to N, and Aₖ are constants three of which must be non-zero, and n is a designator for the respective section.

11. The multi-section transmission line according to claim 10 wherein the length of each of the said sections has been adjusted to be equal to the nearest integer multiple of a sub-multiple of the major cross-sectional dimension of the transmission line where said a sub-multiple does not exceed one part in twenty.

12. The multi-section transmission line according to claim 11 wherein the lowermost frequency of the lowermost band of frequencies is greater than or equal to about 470 MHz and wherein the uppermost frequency of the uppermost band of frequencies is less than or equal to about 806 MHz.

13. The multi-section transmission line according to claim 12 wherein the nominal length L is about 10 feet.

14. A multi-section transmission line having low VSWR characteristics over bands of frequencies comprising a sequence of N sections joined at respective junctioning each one of said N sections having respective lengths l and comprising an inner tubular conductor and an outer tubular conductor which are supported in concentric relationship by flange insulators at the respective junctions between respective sections, each junction causing small impedance discontinuities, the lengths l of the N sections are distributed essentially according to the relationship
$${l}_{n} = L + {\sum }_{k = 0}^{k - m} {{A}_{k} ( \frac{n}{N} )}^{k}$$
for n=1 to N, where L is a nominal section length, k is a summation integer whose value ranges from zero to a value m which latter value is greater than 1 but less than or equal to N, and Aₖ are constants three of which must be non-zero, and n is a designator for the respective section.

15. The multi-section transmission line according to claim 14 wherein the length of each of the said sections has been adjusted to be equal to the nearest integer multiple of a sub-multiple of the wavelength of the uppermost frequency of the uppermost frequency band where said a sub-multiple does not exceed one part in thirty.

16. The multi-section transmission line according to claim 15 wherein the lowermost frequency of the lowermost band of frequencies is greater than or equal to about 54 MHz and wherein the uppermost frequency of the uppermost band of frequencies is less than or equal to about 806 MHz.

17. The multi-section transmission line according to claim 16 wherein the nominal length L is about 20 feet.
